(19) United States
(12) Patent Application Publication
(10) Pub. No.: US 2015/0234592 A1
(43) Pub. Date: Aug. 20, 2015

(54) SYSTEMS, METHODS AND DEVICES FOR INPUT OF CHARACTERS WITH OPTIONAL TIME-BASED BUTTON TAPS

(71) Applicant: Michael William Murphy, Bellingham, WA (US)

(72) Inventor: Michael William Murphy, Bellingham, WA (US)

(21) Appl. No.: 14/627,822

(22) Filed: Feb. 20, 2015

Related U.S. Application Data
(60) Provisional application No. 61/942,592, filed on Feb. 20, 2014.

(51) Int. Cl. G06F 3/0488; G06F 3/0489; G06F 3/0484; G06F 3/023; G06F 3/0482

(52) U.S. Cl. CPC G06F 3/04886; G06F 3/0236; G06F 3/0482; G06F 3/04842; G06F 3/0489

(57) ABSTRACT

Systems, devices and methods are disclosed for input of characters and text with optional time-based button taps. The duration of the activation of a selection button specifies the selected character. In one embodiment, the system enables selection of either of two characters using one selection button based on how long the button was pressed by the user. Each character in an array of a plurality of characters is part of a pair of characters in the array. The system enables selection of any character of the array of characters based on a first character within each pair having an assigned value being a defined amount different than an assigned value of a second character in the pair. Based on received input indicative of the selection button having been activated for a particular duration compared to a threshold duration, the system selects between the assigned value of the first character and the assigned value of the second character within each pair.

### BACKGROUND

### Technical Field

This description generally relates to the field of electronic devices and, more particularly, to user interfaces of electronic devices.

### BRIEF SUMMARY

A computer processor-implemented method may be summarized as including receiving, by at least one computer processor, input resulting from activation of a selection button; and selecting, by at least one computer processor, between at least two characters based on the activation of the selection button wherein a duration of the activation specifies a selected character of the at least two characters. A difference in the duration specifies one character of the at least two characters as the selected character instead of another character of the at least two characters. The at least two characters may be members of a character menu and the selection button may be one of a plurality of selection buttons of an electronic device. The character menu may be a one-dimensional array of a plurality of characters, wherein each character of the plurality of characters is assigned a value according to its position in the array, and the value of the one character of the at least two characters is different from the value of another character of the at least two characters by a defined amount.

Each character in the array of the plurality of characters may be a member of one of a plurality of pairs of characters in the array and the method may further comprise enabling selection of any character of the array based on a first character within each pair having an assigned value different from an assigned value of a second character in the pair by a defined amount and on received input indicative of the selection button having been activated for a particular duration compared to a threshold duration to select between the assigned value of the first character and the assigned value of the second character within each pair. The one-dimensional array may have 26 characters and the received input may result from activation of at least one of four selection keys. The assigned values of the four selection keys may be −3, −2, +2, and +3. The assigned values of the four selection keys may be −3, −1, +1, and +3. The character menu may include two one-dimensional arrays that have 13 characters each and the received input results from activation of at least one of eight selection keys.

A system for facilitating input of characters may be summarized as including at least one processor; and at least one non-transitory computer-readable storage medium coupled to the at least one processor, the at least one non-transitory computer-readable storage medium having computer executable instructions stored thereon that, when executed by the at least one processor, cause the at least one processor to: receive input resulting from activation of a selection button; and select between at least two characters based on the activation of the selection button wherein a duration of the activation specifies a selected character of the at least two characters. A difference in the duration may specify one character of the at least two characters as the selected character instead of another character of the at least two characters. Two characters may be members of a character menu and the selection button may be one of a plurality of selection buttons of an electronic device. The character menu may be a one-dimensional array of a plurality of characters, wherein each character of the plurality of characters is assigned a value according to its position in the array, and the value of the one character is a defined amount different than the value of the other character.

Each character in the array of the plurality of characters may be part of a pair of characters in the array and wherein the computer executable instructions, when executed by the at least one processor, may further cause the at least one processor to: enable selection of any character of the array based on a first character within each pair having an assigned value being the defined amount different than an assigned value of a second character in the pair and on received input indicative of the selection button having been activated for a particular duration compared to a threshold duration to select between the assigned value of the first character and the assigned value of the second character within each pair. The one-dimensional array may have 26 characters and the received input may result from activation of at least one of four selection keys. Assigned values of the four selection keys may be −3, −2, +2, and +3. Assigned values of the four selection keys may be −3, −1, +1, and +3.

A non-transitory computer-readable storage medium having computer-executable instructions stored thereon that, when executed by at least one processor of a computer system, may cause the computer system to: receive input resulting from activation of a selection button; and select between at least two characters based on the activation of the selection button wherein a duration of the activation specifies a selected character of the at least two characters. A difference in the duration may specify one character of the at least two characters as the selected character instead of another character of the at least two characters. The two characters may be members of a character menu and the selection button may be one of a plurality of selection buttons of an electronic device. The character menu may be a one-dimensional array of a plurality of characters, wherein each character of the plurality of characters may be assigned a value according to its position in the array, and the value of the one character may be a defined amount different than the value of the other character.

Each character in the array of the plurality of characters may be part of a pair of characters in the array and wherein the computer executable instructions, when executed by the at least one processor, may further cause the at least one processor to: enable selection of any character of the array based on a first character within each pair having an assigned value being the defined amount different than an assigned value of a second character in the pair and on received input indicative of the selection button having been activated for a particular duration compared to a threshold duration to select between the assigned value of the first character and the assigned value of the second character within each pair. The one-dimensional array may have 26 characters and the received input may result from activation of at least one of four selection keys. Assigned values of the four selection keys may be −3, −2, +2, and +3. Assigned values of the four selection keys may be −3, −1, +1, and +3.

A computer processor-implemented method may be summarized as including receiving, by at least one computer processor, input resulting from activation of a particular selection button of a plurality of selection buttons; determining, by at least one computer processor, a duration of the activation of the particular selection button; comparing, by at least one computer processor, the duration of the activation of the particular selection button to a threshold duration amount to determine whether the duration of the activation surpassed the threshold; and in response to the comparison, selecting, by at least one computer processor, a character from a plurality of characters based on an identification of the particular selection button activated and whether the duration of the activation surpassed the threshold.

The method may further include outputting, by at least one computer processor, the selected character on a display.

A device may be summarized as including at least one processor; and at least one non-transitory computer-readable storage medium coupled to the at least one processor, the at least one non-transitory computer-readable storage medium having computer executable instructions stored thereon that, when executed by the at least one processor, cause the at least one processor to: receive input resulting from activation of a particular selection button of a plurality of selection buttons; determine a duration of the activation of the particular selection button; compare the duration of the activation of the particular selection button to a threshold duration amount to determine whether the duration of the activation surpassed the threshold; and in response to the comparison, select a character from a plurality of characters based on an identification of the particular selection button activated and whether the duration of the activation surpassed the threshold.

The device may further include a display coupled to the at least one processor and wherein the computer executable instructions, when executed by the at least one processor, further cause the at least one processor to output the selected character on the display in response to the character being selected.

A non-transitory computer-readable storage medium having computer-executable instructions stored thereon that, when executed by at least one processor of a computer system, may cause the computer system to: receive input resulting from activation of a particular selection button of a plurality of selection buttons; determine a duration of the activation of the particular selection button; compare the duration of the activation of the particular selection button to a threshold duration amount to determine whether the duration of the activation surpassed the threshold; and in response to the comparison, select a character from a plurality of characters based on an identification of the particular selection button activated and whether the duration of the activation surpassed the threshold.

The computer executable instructions, when executed by the at least one processor, may further cause the at least one processor to output the selected character on a display.

A computer processor-implemented method may be summarized as electronically enabling selection of either of two characters using one selection button by receiving input resulting from activation of the selection button, the duration of the activation specifying the selected character.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn are not intended to convey any information regarding the actual shape of the particular elements, and have been solely selected for ease of recognition in the drawings.

FIG. 1 is a schematic view of an example electronic device for input of characters with optional time-based button taps according to one illustrated embodiment, the electronic device being a mobile device having a housing, a display, a graphics engine, a central processing unit (CPU), user input device(s), one or more storage mediums having various software modules thereon that are executable by the CPU, input/output (I/O) port(s), network interface(s), wireless receiver(s) and transmitter(s), and a power source.

FIG. 2 is another example electronic device, having some or all the components and functionality of the device of FIG. 1, for selecting between two characters using one selection button according to one illustrated embodiment;

FIG. 3 is a flow diagram showing a method for selecting between two characters using one selection button according to one illustrated embodiment.

FIG. 4 is a diagram of a user interface according to one illustrated embodiment.

FIG. 5 is a flow diagram showing a character specification method according to one illustrated embodiment.

FIG. 6 is a diagram of a user interface previously disclosed in FIG. 8 of U.S. Pat. No. 8,487,877, which is hereby incorporated by reference in its entirety.

FIG. 7 is a flow diagram showing a method for specifying a character from a plurality of characters according to one illustrated embodiment.

FIG. 8 is a flow diagram showing a method for inputting characters to an electronic device according to one illustrated embodiment.

### DETAILED DESCRIPTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures associated with computing systems including client and server computing systems, as well as networks, including various types of telecommunications networks, have not been shown or described in detail to avoid unnecessarily obscuring descriptions of the embodiments.

Unless the context requires otherwise, throughout the specification and claims which follow, the word “comprise” and variations thereof, such as “comprises” and “comprising,” are to be construed in an open, inclusive sense, that is, as “including, but not limited to.”

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

The headings and Abstract of the Disclosure provided herein are for convenience only and do not interpret the scope or meaning of the embodiments.

Various embodiments are described herein that provide systems, devices and methods for input of characters with optional time-based button taps.

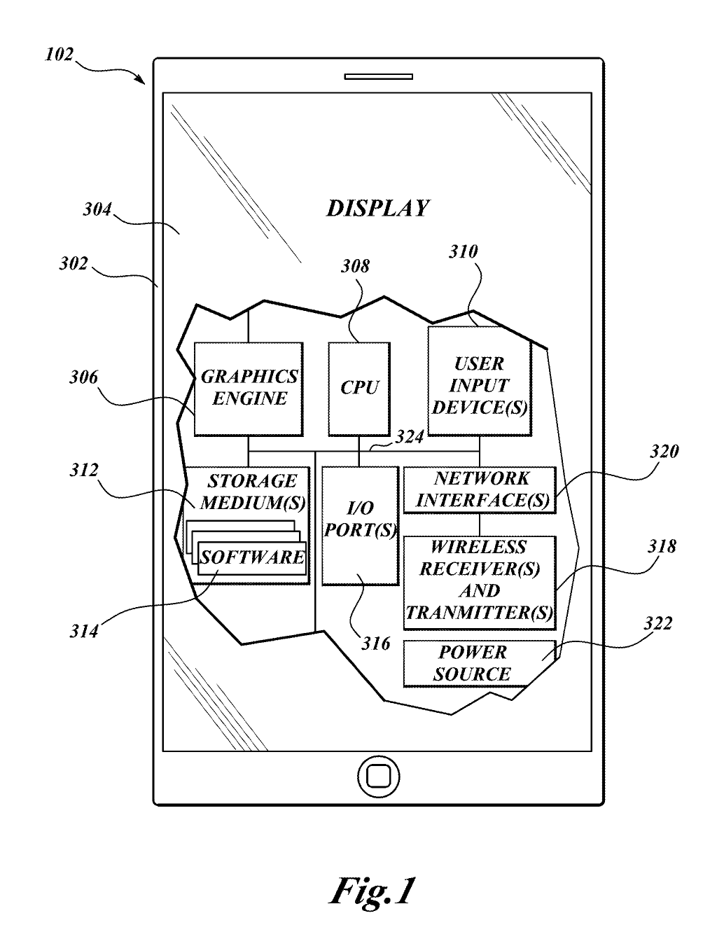

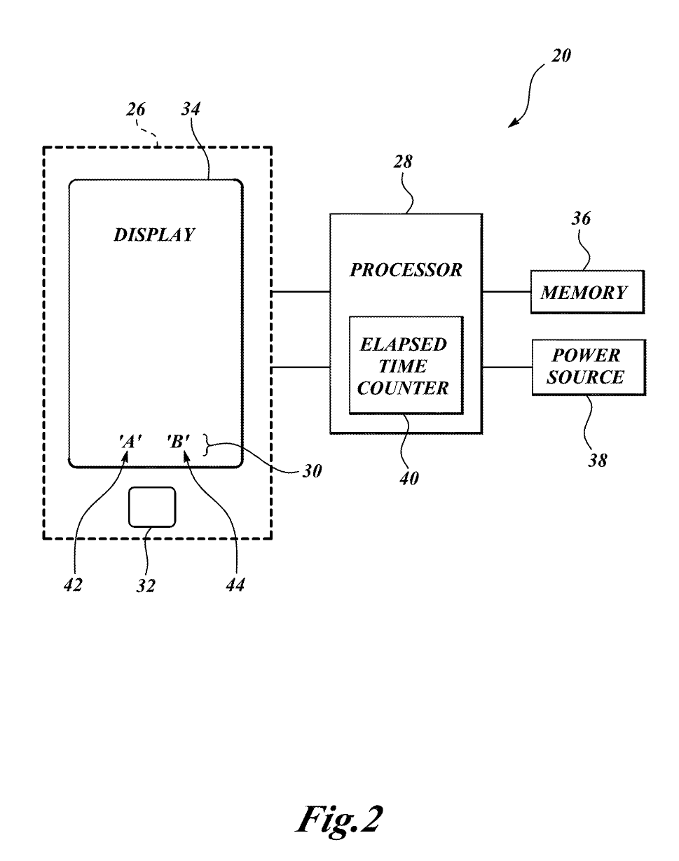

For example, FIG. 1 is a schematic view of one example electronic device, in this case mobile device 102, for input of characters with optional time-based button taps according to one illustrated embodiment. FIG. 2 shows an example of another electronic device for input of characters with optional time-based button taps and may have some or all the components and functionality described herein with respect to the mobile device 102 of FIG. 1. The mobile device 102 shown in FIG. 1 may have a housing 302, a display 304, a graphics engine 306, a central processing unit (CPU) 308, one or more user input devices 310, one or more storage mediums 312 having various software modules 314 stored thereon comprising instructions that are executable by the CPU 308, input/output (I/O) port(s) 316, one or more wireless receivers and transmitters 318, one or more network interfaces 320, and a power source 322. In some embodiments, some or all of the same, similar or equivalent structure and functionality of the mobile device 102 shown in FIG. 1 and described herein may be that of, part of or operably connected to a communication and/or computing system of another device or machine.

The mobile device 102 may be any of a large variety of communications devices such as a cellular telephone, a smartphone, a portable media player (PMP), a personal digital assistant (PDA), a mobile communications device, a portable computer with built-in or add-on cellular communications, a portable game console, a global positioning system (GPS), a handheld industrial electronic device, or the like, or any combination thereof. The mobile device 102 has at least one central processing unit (CPU) 308 which may be a scalar processor, a digital signal processor (DSP), a reduced instruction set (RISC) processor, or any other suitable processor. The central processing unit (CPU) 308, display 304, graphics engine 306, one or more user input devices 310, one or more storage mediums 312, input/output (I/O) port(s) 316, one or more wireless receivers and transmitters 318, and one or more network interfaces 320 may all be communicatively connected to each other via a system bus 324. The system bus 324 can employ any suitable bus structures or architectures, including a memory bus with a memory controller, a peripheral bus, and/or a local bus.

The mobile device 102 also includes one or more volatile and/or non-volatile storage medium(s) 312. The storage mediums 312 may be comprised of any single or suitable combination of various types of processor-readable storage media and may store instructions and data acted on by CPU 308. For example, a particular collection of software instructions comprising software 314 and/or firmware instructions comprising firmware are executed by CPU 308. The software or firmware instructions generally control many of the operations of the mobile device 102 and a subset of the software and/or firmware instructions may perform functions to operatively configure hardware and other software in the mobile device 102 to provide the initiation, control and maintenance of applicable computer network and telecommunication links from the mobile device 102 to other devices using the wireless receiver(s) and transmitter(s) 318, network interface(s) 320, and/or I/O ports 316.

By way of example, and not limitation, the storage medium(s) 312 may be processor-readable storage media which may comprise any combination of computer storage media including volatile and nonvolatile, removable and non-removable media implemented in any method or technology for storage of information such as computer-readable instructions, data structures, program modules or other data. Combinations of any of the above should also be included within the scope of processor-readable storage media. The storage medium(s) 312 may include system memory which includes computer storage media in the form of volatile and/or nonvolatile memory such as read-only memory (ROM) and random access memory (RAM). A basic input/output system (BIOS), containing the basic routines that help to transfer information between elements within mobile device 102, such as during start-up or power-on, is typically stored in ROM. RAM typically contains data and/or program modules that are immediately accessible to and/or presently being operated on by CPU 308. By way of example, and not limitation, FIG. 1 illustrates software modules 314 including an operating system, application programs and other program modules that implement the processes and methods described herein.

The mobile device 102 may also include other removable/non-removable, volatile/nonvolatile computer storage media drives. By way of example only, the storage medium(s) 312 may include a hard disk drive or solid state storage drive that reads from or writes to non-removable, nonvolatile media, a SSD that reads from or writes to a removable, nonvolatile SSD, and/or an optical disk drive that reads from or writes to a removable, nonvolatile optical disk such as a DVD-RW or other optical media. Other removable/non-removable, volatile/nonvolatile computer storage media that can be used in an operating environment of the mobile device 102 include, but are not limited to, flash memory cards, other types of digital versatile disks (DVDs), micro-discs, digital video tape, solid state RAM, solid state ROM, and the like. The storage medium(s) are typically connected to the system bus 324 through a non-removable memory interface. The storage medium(s) 312, discussed above and illustrated in FIG. 1, provide storage of computer-readable instructions, data structures, program modules and other data for the mobile device 102. In FIG. 1, for example, a storage medium may store software 314 including an operating system, application programs, other program modules, and program data. The storage medium(s) 312 may implement a file system, a flat memory architecture, a database, or any other method or combination capable of storing such information.

A user may enter commands and information into the mobile device 102 through touch screen display 304 or the one or more other input device(s) 310 such as a keypad, keyboard, camera, motion sensor, position sensor, light sensor, biometric data sensor, accelerometer, or a pointing device, commonly referred to as a mouse, trackball or touch pad. Other input devices of the mobile device 102 may include a microphone, joystick, thumbstick, game pad, optical scanner, other sensors, or the like. These and other input devices are often connected to the CPU 308 through a user input interface that is coupled to the system bus 324, but may be connected by other interface and bus structures, such as a parallel port, serial port, wireless port, game port or a universal serial bus (USB). Generally, a unique software driver stored in software 314 configures each input mechanism to sense user input, and then the software driver provides data points that are acted on by CPU 308 under the direction of other software 314. The display is also connected to the system bus 324 via an interface, such as the graphics engine 306. In addition to the display 304, the mobile device 102 may also include other peripheral output devices such as speakers, a printer, a projector, an external monitor, etc., which may be connected through one or more analog or digital I/O ports 316, network interface(s) 320 or wireless receiver(s) and transmitter(s) 318. The mobile device 102 may operate in a networked environment using connections to one or more remote computers or devices, such as a remote computer or device.

When used in a LAN or WAN networking environment, the mobile device 102 may be connected via the wireless receiver(s) and transmitter(s) 318 and network interface(s) 320, which may include, for example, cellular receiver(s) and transmitter(s), Wi-Fi receiver(s) and transmitter(s), and associated network interface(s). When used in a WAN networking environment, the mobile device 102 may include a modem or other means as part of the network interface(s) for establishing communications over the WAN, such as the Internet. The wireless receiver(s) and transmitter(s) 318 and the network interface(s) 320 may be communicatively connected to the system bus 324. In a networked environment, program modules depicted relative to the mobile device 102, or portions thereof, may be stored in a remote memory storage device of a remote system.

The mobile device 102 has a collection of I/O ports 316 and/or short range wireless receiver(s) and transmitter(s) 318 and network interface(s) 320 for passing data over short distances to and from the mobile device 102 or for coupling additional storage to the mobile device 102. For example, serial ports, USB ports, Wi-Fi ports, Bluetooth® ports, IEEE 1394 (i.e., FireWire), and the like can communicatively couple the mobile device 102 to other computing apparatuses. Compact Flash (CF) ports, Secure Digital (SD) ports, and the like can couple a memory device to the mobile device 102 for reading and writing by the CPU 308 or couple the mobile device 102 to other communications interfaces such as Wi-Fi or Bluetooth transmitters/receivers and/or network interfaces.

Mobile device 102 also has a power source 322 (e.g., a battery). The power source 322 may supply energy for all the components of the mobile device 102 that require power when a traditional, wired or wireless power source is unavailable or otherwise not connected. Other various suitable system architectures and designs of the mobile device 102 are contemplated and may be utilized which provide the same, similar or equivalent functionality as those described herein.

It should be understood that the various techniques, components and modules described herein may be implemented in connection with hardware, software and/or firmware or, where appropriate, with a combination of such. Thus, the methods and apparatus of the disclosure, or certain aspects or portions thereof, may take the form of program code (i.e., instructions) embodied in tangible media, such as various solid state memory devices, DVD-RW, RAM, hard drives, flash drives, or any other machine-readable or processor-readable storage medium wherein, when the program code is loaded into and executed by a machine, such as a processor of a computer, vehicle or mobile device, the machine becomes an apparatus for practicing various embodiments. In the case of program code execution on programmable computers, vehicles or mobile devices, such generally includes a processor, a storage medium readable by the processor (including volatile and non-volatile memory and/or storage elements), at least one input device, and at least one output device. One or more programs may implement or utilize the processes described in connection with the disclosure, e.g., through the use of an API, reusable controls, or the like. Such programs are preferably implemented in a high level procedural or object oriented programming language to communicate with a computer system of mobile device 102. However, the program(s) can be implemented in assembly or machine language, if desired. In any case, the language may be a compiled or interpreted language, and combined with hardware implementations.

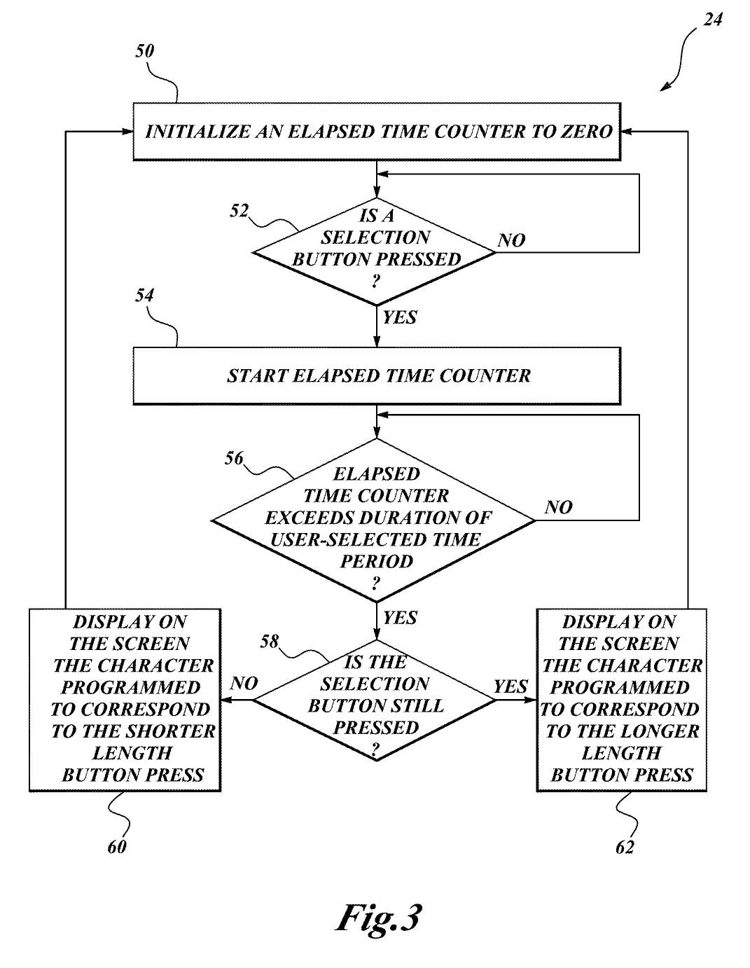

FIGS. 2 and 3 show, respectively, an electronic device 20 and a method 24 for selecting between two characters using one selection button in accordance with one embodiment.

FIG. 2 shows a schematic drawing of the electronic device 20 in accordance with one embodiment. The electronic device 20 includes a front face 26, a computer processor 28, a character menu 30, a selection button 32, a display screen 34, a memory 36, and a power source 38. The processor 28 includes an elapsed time counter 40. The elapsed time counter 40 may be implemented using a timer circuit operably connected to or as part of the processor 28. Alternately some or all of the elapsed time counter 40 may be implemented in computer software as computer executable instructions stored on a non-transitory computer-readable storage medium, such as memory 36, for example, that when executed by processor 28 or a processor of a timer circuit, perform the functions described herein of the elapsed time counter 40. The character menu 30 displays two characters—in this embodiment the characters ‘A’ 42 and ‘B’ 44. The selection button 32, the display screen 34, the memory 36, and the power source 38 are communicatively coupled to one another through at least the processor 28. The selection button 32 and the display screen 34, including the two displayed characters 42, 44, are located on the front face 26 of the electronic device 20.

FIG. 3 shows a flowchart of the method 24 for selecting between two characters using one button in accordance with one embodiment.

In one step 50 of the method, the device 20 initializes the elapsed time counter 40 in the processor 28 to zero.

In a next step 52, the processor 28 monitors whether the selection button 32 has been pressed.

In another step 54, once the processor 28 determines the selection button 32 is pressed, the processor starts the elapsed time counter 40.

In another step 56, the processor 28 compares the elapsed time from the counter 40 with a pre-selected time duration chosen by a user.

In another step 58, once the elapsed time reaches the pre-selected time duration (i.e., expires), the processor 28 evaluates whether the selection button 32 is still pressed.

In another step 60, if the selection button 32 is no longer pressed, the processor 28 registers as input the character programmed to correspond with a shorter length button press, in this example character ‘A’ 42.

In another step 62, if the selection button 32 is still pressed, the processor 28 registers as input the character programmed to correspond with a longer length button press, in this example the character ‘B’ 44.

In a repeating step 50, the processor 28 re-initializes the elapsed time counter 40 to zero.

Several definitions come out of the method disclosed above. A ‘short’ button press is one whose duration is shorter than the user-selected time period. A ‘long’ button press is one whose duration exceeds the length of the user-selected time period. The moment in time that distinguishes a ‘short’ button press from a ‘long’ button press is the ‘threshold’ between them.

Clearly, in alternative embodiments, the exact characters made available for selection in the character menu 30, and their specific assignment to either a ‘short’ or ‘long’ button press, can be different and may be selectable.

In descriptive terms, the electronic device 20 is programmed to measure the time duration of a button press and distinguish between short and long presses. The point in time from which the duration is measured is from when the user initially presses the selection button 20. If the user releases the selection button 20 before the time period expires, then a ‘short’ button press is interpreted by the device. If when the time period expires, the selected button is still maintained, a ‘long’ button press is interpreted. By assigning one character to a short button press and another character to a long button press, the method 24 enables either of two characters 42, 44 to be selected using a single selection button 20. In one embodiment, the duration of a typical user-selectable time period is 0.15 seconds, but clearly any length time period is contemplated and is considered within the scope of the present disclosure.

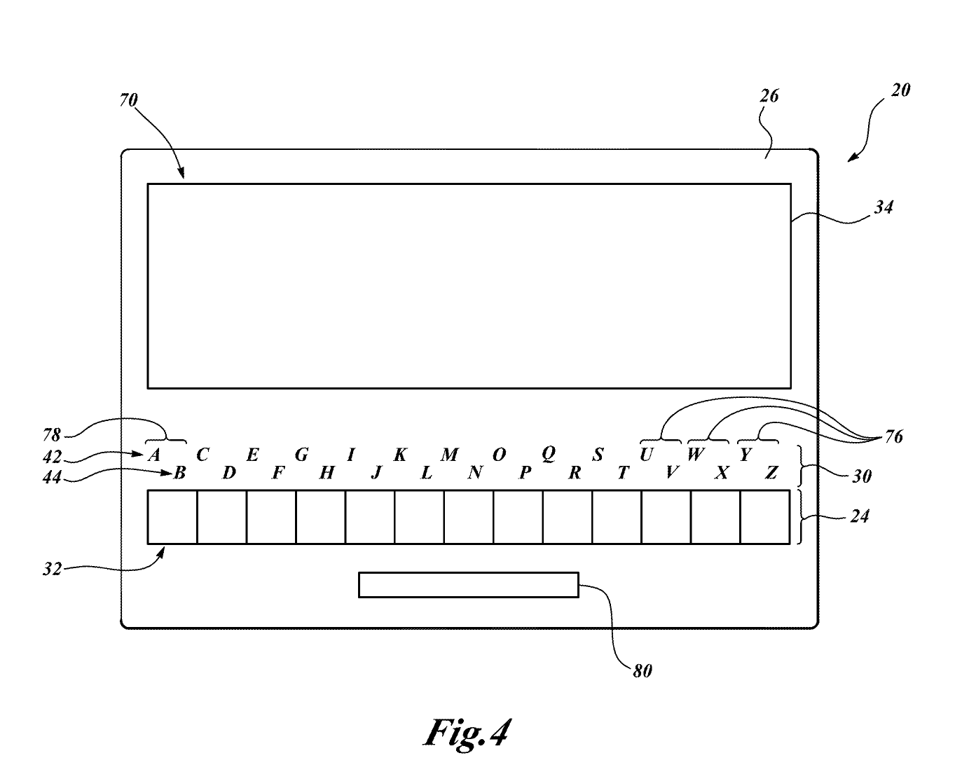

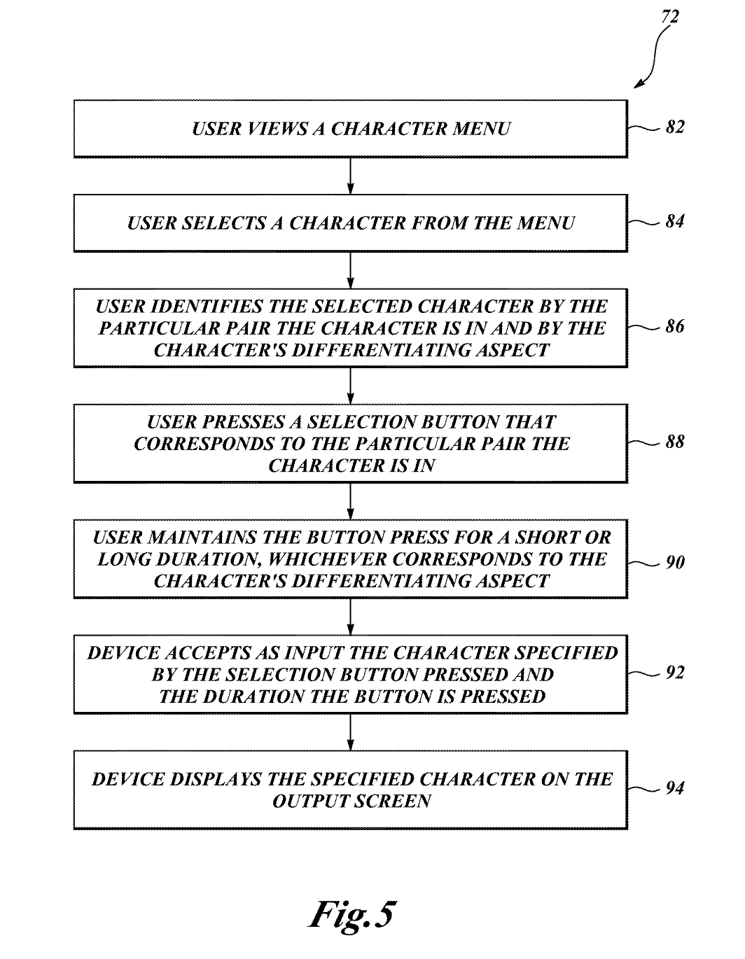

FIGS. 4 and 5 show, respectively, a user interface 70 and a character specification method 72 in accordance with another embodiment.

The device on which the user interface 70 is implemented may be a device such as that in FIG. 1 or FIG. 2 and such a device may, for example, include the elements 26, 30, 32, 34, 42, 44 of the electronic device 20 shown in the embodiment of FIG. 2, except that the character menu 30 is expanded to include more than just the characters ‘A’ 42 and ‘B’ 44. Furthermore the single selection button 32 is expanded to include a plurality of selection buttons 74. All the elements 26, 30, 32, 34, 42, 44 and the plurality of selection buttons 74 are located on the front face 26 of the electronic device 20. The display screen 34, the plurality of selection buttons 74, and the spacebar button 80 are communicatively coupled with the processor 28 in a way similar to the embodiment of FIG. 2.

Individual characters of the menu 30 are arranged in pairs 76 on the face 26 of the device 20. In the embodiment of FIG. 4, individual characters are recognizable as pairs 76 by their close proximity to one another relative to other nearby characters. In alternative embodiments, two characters could also be identifiable as a pair by (1) the degree of proximity to one another, (2) common coloring, shading, size or font, (3) a visible feature such as circle or bracket that raises an association between two characters, or (4) a myriad number of other ways that characters can be visually associated with one another to the exclusion of the rest of the characters.

Although characters of a pair 76 have a common feature (such as proximity) so a user can recognize the two as a pair, the characters also have an aspect that differentiates the two from one another in some way. In the embodiment of FIG. 4, the characters ‘A’ 42 and ‘B’ 44 within a first pair 78 are differentiated from one another by their position with respect to one another—‘A’ is positioned above and to the left of ‘B’. Note that this differentiation is carried out uniformly across all pairs 76 of the menu 30. In other words, all the pairs 76 have their characters 42, 44 arranged diagonally with respect to one another. In alternative embodiments, characters within a pair 76 are differentiated by color, font, size, the color or shading of a background, a dot or other visible feature positioned next to one or both characters in each pair, or in nearly a limitless number of ways that two characters can be differentiated.

The plurality of selection buttons 74 lie on the face 26 of the device 20 and can be either hard keys (physical buttons) or soft keys (buttons implemented on the display screen). In the embodiment of FIG. 4 the selection buttons 74 are shown as physical buttons. In either case, the buttons 74 are communicatively coupled with the processor 28 and each button is assigned to just one of the character pairs 76. The device 20 is programmed so that when a selection button is pressed, one of the characters from the pair 76 to which the button is assigned is input to the device. Which of the two characters is entered is explained in the method 72 disclosed in the description of FIG. 5, which follows.

In the embodiment of FIG. 4, each character pair 76 is positioned next to the particular selection button 74 to which it is assigned. However, alternative embodiments where the character menu 30 is not in close proximity to the selection buttons are still within the scope of the present disclosure. Furthermore, in one alternative embodiment, the character menu 30 is displayed on the display screen 34.

The user interface 70 also includes a spacebar button 80 on the face 26 of the device 20 communicatively coupled with the processor 28. The display screen 34 is one of a variety of electronic display screens known in the industry and may be touch sensitive and include touch-activation capability.

FIG. 5 shows a flowchart that illustrates a method 72 for specifying a character from among a plurality of characters in accordance with the user interface 70 of FIG. 4.

In one step 82, a user views the character menu 30 on the face 26 of the device 20.

In another step 84, the user selects a specific character from the menu 30 for input to the device 20. For example, the user selects the character ‘B’ 44.

In another step 86, the user identifies the selected character by (1) the particular pair 76 that the character is in and (2) the selected character's differentiating aspect. For example, the character ‘B’ 44 is in the first pair 78 of the menu 30 and its differentiating aspect is that it is below and to the right of the character ‘A’ 42.

In another step 88, the user presses the selection button 74 that corresponds to the particular pair 76 the selected character is in. In the ongoing example, to select the character ‘B’ 44, the first selection button 32 is pressed.

In another step 90, the user maintains the button press for either a ‘short’ or ‘long’ duration, depending on the assignment of characters in the menu and the character desired. In the ongoing example, let a ‘short’ button-press select the upper-left-hand character in a pair and let a ‘long’ button-press select the lower-right-hand character of a pair. In this case, for the example being given, the user holds the selection button 32 down until the user-selected time period expires (a ‘long’ button-press) in order to select ‘B’ 44. The assignment of short and long button presses to one or the other character in the pair is selectable and may vary. Either assignment is contemplated and is within the scope of various embodiments.

In another step 92, the character specified by the particular selection button pressed and the duration of the button-press is entered as input to the device 20.

In another step 94, the specified character is displayed on the display screen 54 of the user interface 70.

In one embodiment of the method, selected characters are input to the device immediately upon the time period's expiration, irrespective of whether the selection button 32 continues to be pressed or not. Once the time period expires, the ambiguity about which character the user wants is removed. At that point, the elapsed time counter 40 can be reinitialized and is ready for the next button press.

In another embodiment of the user interface 70 and the character specification method 72, the method 72 is used iteratively to select a series of characters from the character menu 30. In this embodiment, subsequent iterations of the method 72 are initiated each time a new selection button is pressed.

In yet another embodiment, words and sentences are constructed on the display screen 34 by iteratively specifying characters according to the method 72 above and by pressing the spacebar button 80 to input spaces between words on the screen 34.

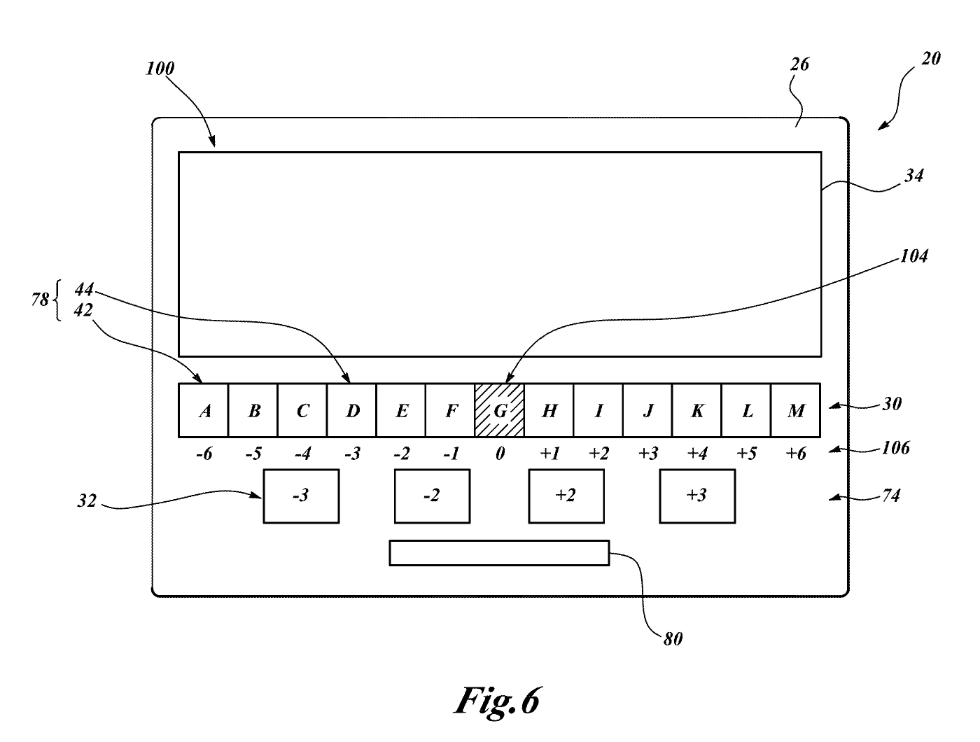

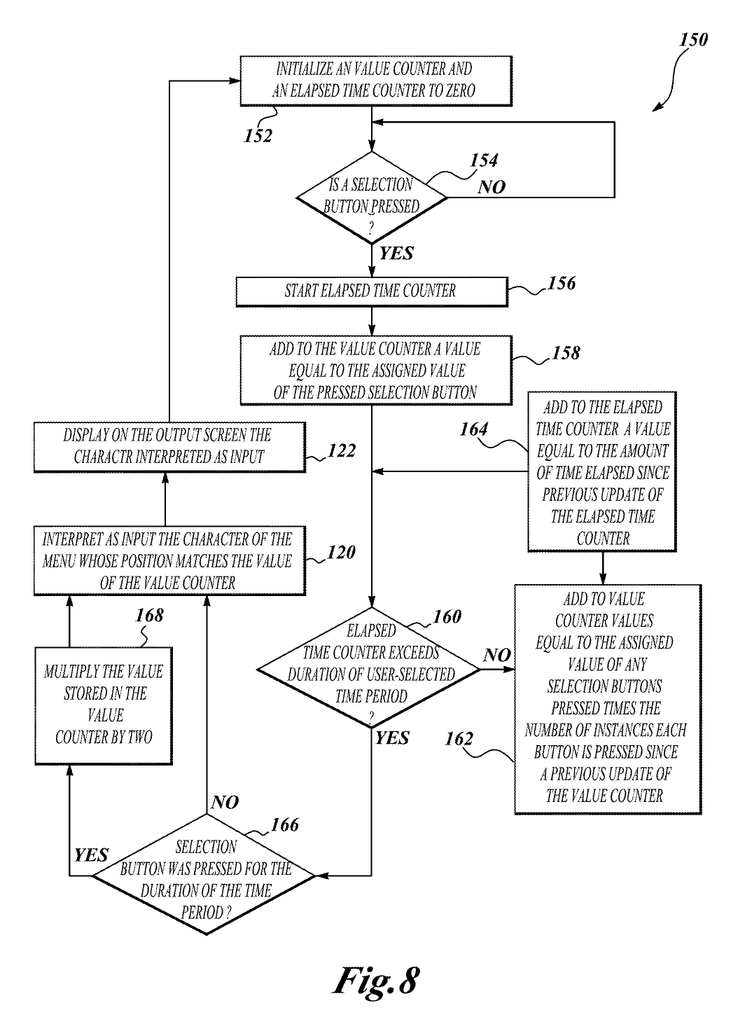

FIG. 6 shows a user interface 100, aspects of which were previously disclosed in FIG. 8 of U.S. Pat. No. 8,487,877, which is hereby incorporated by reference in its entirety.

The user interface 100 includes the character menu 30, individual selection button 32, the display screen 34, the plurality of selection buttons 74, individual characters 42, 44 within the character pair 78 and the spacebar button 80 on the front face 26 of the device 20.

The interface 100 further includes a reference 104 in the character menu 30 and an offset scale 106 on the front face 26. The display screen 34, the plurality of selection buttons 74, and the spacebar button 80 are communicatively coupled with the processor 28, as described in the embodiments from FIGS. 2 and 4.

In the embodiment of FIG. 6, the characters of the menu 30 are arranged in a one-dimensional array consistent with the embodiment in FIG. 8 of U.S. Pat. No. 8,487,877. In this embodiment, the characters 42, 44 of the character pair 78 are distributed within the one-dimensional array. Each character is assigned a value according to its position in the one-dimensional array. Either is selectable using the selection button 32 according to the method 72 which follows.

The plurality of selection buttons 74 on the face 26 of the device 20 can be either hard keys (physical buttons) or soft keys (buttons shown on the display screen). In the embodiment of FIG. 6, the selection buttons 74 are shown as physical buttons. In either case, the buttons 74 are communicatively coupled with the processor 28.

The character menu 30 and the offset scale 106 are positioned in respective one-dimensional arrays on the face 26 of the device 20. In one embodiment the character menu 30 and the offset scale 106 are positioned on the device 20 so that they lie adjacent to and parallel with one other. In one embodiment, both the character menu 30 and the offset scale 106 are physical features located directly on the face of the device, but in another embodiment they are programmed in software so that they appear as features on the display screen 34 of the device 20. In yet another embodiment, the character menu 30 is displayed on the display screen 30 and the offset scale 106 is located in a parallel one-dimensional array physically on the face 26 of the device.

In one embodiment, individual characters of the character menu 30 are distributed in a one-dimensional array in evenly spaced increments. In a further embodiment, values of the offset scale 106 are distributed in a one-dimensional array in increments that match the increment of the character menu 30, so that by referencing the offset scale 106 to the character menu 30, characters in the menu 30 are effectively numbered.

The reference 104 is an indicator located near or on one of the characters of the menu 30. The offset scale 106 includes a value of zero that is located to correspond with the reference 104 in the menu 30. Values of the offset scale 104 increase from zero in pre-selected increments as positions of the offset scale get farther from the zero value. In a further embodiment, values of the offset scale 104 decrease from zero in pre-selected increments as positions of the offset scale get farther from the zero value in a direction opposite to the increasing direction. In one embodiment, the pre-selected increment of the offset scale 106 equals one and the values of the offset scale 106 extend from a negative value to a positive value passing through zero.

In one specific embodiment, the character menu 30 and the values of the offset scale 106 are each distributed in respective one-dimensional arrays positioned adjacent to and parallel with one another, the values of the offset scale 106 count in increments of one and are spaced with respect to one another in their array to correspond with the spacing of positions in the character menu 30, and the zero value in the offset scale 106 corresponds to the reference 104 of the character menu 30 so that the values of the offset scale 106 label the positions of the character menu 30 according to how many positions a given position in the menu 30 is offset from the reference 104.

The plurality of selection buttons 74 lie on the face 26 of the device 20 and, as described above, can be either hard or soft keys. Each button is communicatively coupled with the device 20 and is assigned a value. The assigned value can be either positive or negative. Each button 74 has the function that, when the button is pressed, a value assigned to the button is input to the device 20. In one embodiment, the assigned value of each selection button is unique. In another embodiment there are four selection buttons and the buttons' assigned values are −3, −2, +2, and +3. In still another embodiment there are four selection buttons and the buttons' assigned values are −3, −1, +1, and +3. The spacebar 80 also lies on the face 26 of the device 20, can be either a hard or soft key, and is communicatively coupled with the device 20.

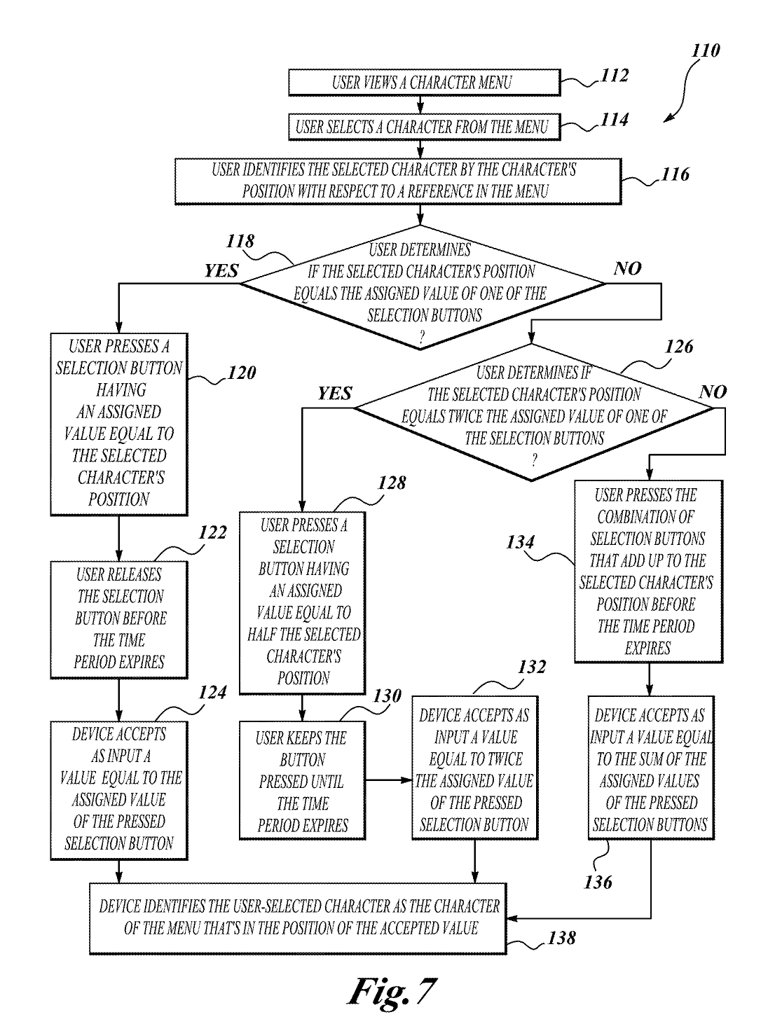

FIGS. 7 and 8 show flowcharts for, respectively, an embodiment of a method 110 for specifying a character from a plurality of characters and an embodiment of a method 150 for inputting characters to an electronic device—both embodiments may be used in conjunction with the user interface 100 of FIG. 6.

In one step 112 of the method 110 for specifying a character, a user views a plurality of characters in the character menu 30.

In another step 114, the user selects a character from the character menu 30 that is desired for specification.

In another step 116, the user identifies the selected character by the position of the character with respect to the reference 104 in the menu 30, for example by a value equal to the number of positions the selected character is offset from the reference 104 of the character menu 30. The user can identify the position of the selected character in a number of ways, including by referencing the position to a corresponding value in the offset scale 106, counting the number of positions that the selected character is offset from the reference 104, recalling from memory the value that identifies the particular selected character, and recalling by muscle memory the selection button keystrokes that correspond with the selected character or the selected character's position.

In another step 118, the user determines if the selected character's position in the menu matches an assigned value for any of the selection buttons 74.

If the answer to the determination of step 118 is yes, then (1) in a subsequent step 120 the user presses the selection button that has an assigned value that matches the selected character's position, (2) in another subsequent step 122 the user releases the selection button before the user-selected time period expires, and (3) in another step 124 the device accepts as input a value equal to the assigned value of the pressed selection button. The time period of step 122 may be the same the user-selectable time period (also called time duration) disclosed in the embodiment of FIG. 3.

If the answer to the determination of step 118 is no, then the user determines in a subsequent step 126 if the selected character's position in the menu matches twice the assigned value of any of the selection buttons 74.

If the answer to the determination of step 126 is yes, then (1) in a subsequent step 128 the user presses the selection button that has an assigned value that is half of the value of the selected character's position, (2) in another subsequent step 130 the user continues to press the selection button until the user-selected time period expires, and (3) in another step 132 the device accepts as input a value equal to twice the assigned value of the pressed selection button.

If the answer to the determination of step 126 is no, then (1) in a subsequent step 134 the user presses the combination of selection buttons that have assigned values that add up to the selected character's position, doing so before the user-selectable time period expires, and (2) in a subsequent step 136 the device accepts as input a value equal to the sum of the pressed selection buttons.

In another step 138, the device 20 identifies the user-selected character as the character of the menu 30 whose position matches the value input in either step 124, step 130, or step 136, depending on the path of the flowchart that was followed.

In another step, the identified character is displayed on the display screen 34 of the user interface 100.

In descriptive terms, the electronic device 20 is programmed to measure the time duration of a button press and distinguish between short and long presses. The point in time from which the duration is measured is from when the user initially presses the selection button 20. If the user releases the selection button 20 before the time period expires, then a ‘short’ button press is interpreted by the device. If when the time period expires, the selected button is still maintained, a ‘long’ button press is interpreted. By assigning a short button press to a character in position −3, for example, and a long button press to a character in position −6, for example, the method 110 enables either of two characters 42, 44 to be selected using a single selection button 32, for example.

The assignment of short and long button presses to one or the other character in the pair is selectable and may vary. Any assignment of either button press or position is contemplated and is within the scope of various embodiments. But in one embodiment, short and long button presses are assigned to characters of the array such that the short and long press of a given button are assigned to two characters of the array, where the position of one character is twice the value of the position of the other character.

In one embodiment, the duration of a typical user-selectable time period is 0.15 seconds, but clearly any length time period is contemplated and is considered within the scope of the present disclosure.

According to another embodiment, the character specification method 110 is used iteratively to specify a series of characters from the plurality of characters displayed in the character menu 30. In one embodiment, words and sentences are constructed on the display screen 34 by iteratively specifying characters according to the method 110 above, with the spacebar 80 used to input spaces between words on the display screen 34.

FIG. 8 shows one embodiment of a text entry method 150 for inputting characters to an electronic device, although there are many alternative embodiments of the method that are within the scope of the present disclosure.

In one step 152, the device 20 initializes a value counter and an elapsed time counter to zero.

In another step 156, the device starts the elapsed time counter when it receives indication from a previous step 154 that a selection button has been pressed.

In another step 158, the device adds to the value counter a value equal to the assigned value of the selection button pressed.

In another step 160, the device compares the elapsed time counter with a previously selected time period to determine if the counter exceeds a pre-selected duration.

If the elapsed time counter does not exceed the pre-selected duration, in another step 162 the device adds to the value counter values equal to the assigned value of any selection buttons pressed times the number of instances each button is pressed since a previous update of the value counter.

In another step 164, the device adds to the elapsed time counter a value equal to the amount of time elapsed since a previous update of the elapsed time counter.

Once the elapsed time counter exceeds the pre-selected duration, in another step 166, the device evaluates whether the selection button that initiated the elapsed time counter was pressed for the duration of the elapsed time period.

If the selection button was pressed for the duration of the time period, then in another step 168 the device multiplies the value stored in the value counter by two.

If the selection button was released before the time period expired, then the device leaves the value counter unchanged.

In another step 170, the device identifies as input the character of the menu 30 whose position matches the value stored in the value counter.

In another step 172, the device displays on the display screen 34 the character identified as the input character.

In a repeating step 152, the device reinitializes the value counter and elapsed time counter back to zero.

Said another way, in accordance with the method 150, the device correlates selection button presses to a specific character by calculating a value from the selection button presses and then matching the calculated value with a position in the array that holds the specific character. As an additional option to this method, for characters of the menu selectable using consecutive button clicks of the same button, a user can select the character by simply holding the selection button down for the duration of the user-selectable time period instead of pressing the selection button twice.

Although the text entry method 150 of FIG. 8 is one embodiment of a method for specifying a series of characters, the scope of the method is not limited by this embodiment, but should be construed to include all possible embodiments along with the full scope of equivalents to which such claims are entitled.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A computer processor-implemented method comprising:
receiving, by at least one computer processor, input resulting from activation of a selection button; and
selecting, by at least one computer processor, between at least two characters based on the activation of the selection button wherein a duration of the activation specifies a selected character of the at least two characters.

2. The method of claim 1 wherein a difference in the duration specifies one character of the at least two characters as the selected character instead of another character of the at least two characters.

3. The method of claim 2 wherein the at least two characters are members of a character menu and the selection button is one of a plurality of selection buttons of an electronic device.

4. The method of claim 2 wherein the character menu is a one-dimensional array of a plurality of characters, wherein each character of the plurality of characters is assigned value according to its position in the array, and the value of the one character of the at least two characters is different from the value of the another character of the at least two characters by a defined amount.

5. The method of claim 4 wherein each character in the array of the plurality of characters is a member of one of a plurality of pairs of characters in the array and further comprising:
enabling selection of any character of the array based on a first character within each pair having an assigned value different from an assigned value of a second character in the pair by a defined amount and on received input indicative of the selection button having been activated for a particular duration compared to a threshold duration to select between the assigned value of the first character and the assigned value of the second character within each pair.

6. The method of claim 4 wherein the one-dimensional array has 13 characters and the received input results from activation of at least one of four selection keys.

7. The method of claim 6 wherein the assigned values of the four selection keys are −3, −2, +2, and +3.

8. The method of claim 6 wherein the assigned values of the four selection keys are −3, −1, +1, and +3.

9. The method of claim 4 wherein the character menu includes two one-dimensional arrays that have 13 characters each and the received input results from activation of at least one of eight selection keys.

10. The method of claim 4 wherein the defined amount is the smaller of an absolute value of the two values.

11. A system for facilitating input of characters comprising:
at least one processor; and
at least one non-transitory computer-readable storage medium coupled to the at least one processor, the at least one non-transitory computer-readable storage medium having computer executable instructions stored thereon that, when executed by the at least one processor, cause the at least one processor to:
receive input resulting from activation of a selection button; and
select between at least two characters based on the activation of the selection button wherein a duration of the activation specifies a selected character of the at least two characters.

12. The system of claim 11 wherein a difference in the duration specifies one character of the at least two characters as the selected character instead of another character of the at least two characters.

13. The system of claim 12 wherein the at least two characters are members of a character menu and the selection button is one of a plurality of selection buttons of an electronic device.

14. The system of claim 12 wherein the character menu is a
one-dimensional array of a plurality of characters, wherein each character of the plurality of characters is assigned a value according to its position in the array, and the value of the one character of the at least two characters is different from the value of the another character of the at least two characters by a defined amount.

15. The system of claim 14 wherein each character in the array of the plurality of characters is a member of one of a plurality of pairs of characters in the array and wherein the computer executable instructions, when executed by the at least one processor, further cause the at least one processor to:
enable selection of any character of the array based on a first character within each pair having an assigned value different from an assigned value of a second character in the pair by a defined amount and on received input indicative of the selection button having been activated for a particular duration compared to a threshold duration to select between the assigned value of the first character and the assigned value of the second character within each pair.

16. The system of claim 14 wherein the one-dimensional array has 26 characters and the received input results from activation of at least one of four selection keys.

17. The system of claim 16 wherein assigned values of the four selection keys are −3, −2, +2, and +3.

18. The system of claim 16 wherein assigned values of the four selection keys are −3, −1, +1, and +3.

19. The system of claim 14 wherein the defined amount is the smaller of the absolute value of the two values.

20. A non-transitory computer-readable storage medium having computer-executable instructions stored thereon that, when executed by at least one processor of a computer system, cause the computer system to:
receive input resulting from activation of a selection button; and
select between at least two characters based on the activation of the selection button wherein a duration of the activation specifies a selected character of the at least two characters.

21. The non-transitory computer-readable storage medium of claim 20 wherein a difference in the duration specifies one character of the at least two characters as the selected character instead of another character of the at least two characters.

22. The non-transitory computer-readable storage medium of claim 20 wherein the two characters are members of a character menu and the selection button is one of a plurality of selection buttons of an electronic device.

23. The non-transitory computer-readable storage medium of claim 22 wherein the character menu is a one-dimensional array of a plurality of characters, wherein each character of the plurality of characters is assigned a value according to its position in the array, and the value of the one character of the at least two characters is different from the value of another character of the at least two characters by a defined amount.

24. The non-transitory computer-readable storage medium of claim 23 wherein each character in the array of the plurality of characters is part of a pair of characters in the array and wherein the computer executable instructions, when executed by the at least one processor, further cause the at least one processor to:
enable selection of any character of the array based on a first character within each pair having an assigned value different from an assigned value of a second character in the pair by a defined amount and on received input indicative of the selection button having been activated for a particular duration compared to a threshold duration to select between the assigned value of the first character and the assigned value of the second character within each pair.

25. The non-transitory computer-readable storage medium of claim 23 wherein the one-dimensional array has 26 characters and the received input results from activation of at least one of four selection keys.

26. The non-transitory computer-readable storage medium of claim 25 wherein assigned values of the four selection keys are −3, −2, +2, and +3.

27. The non-transitory computer-readable storage medium of claim 25 wherein assigned values of the four selection keys are −3, −1, +1, and +3.

28. The non-transitory computer-readable storage medium of claim 23 wherein the defined amount is the smaller of the absolute value of the two values.

29. A computer processor-implemented method comprising:
receiving, by at least one computer processor, input resulting from activation of a particular selection button of a plurality of selection buttons;
determining, by at least one computer processor, a duration of the activation of the particular selection button;
comparing, by at least one computer processor, the duration of the activation of the particular selection button to a threshold duration amount to determine whether the duration of the activation surpassed the threshold; and
in response to the comparison, selecting, by at least one computer processor, a character from a plurality of characters based on an identification of the particular selection button activated and whether the duration of the activation surpassed the threshold.

30. The method of claim 29 further comprising outputting, by at least one computer processor, the selected character on a display.

31. A device comprising:
at least one processor; and
at least one non-transitory computer-readable storage medium coupled to the at least one processor, the at least one non-transitory computer-readable storage medium having computer executable instructions stored thereon that, when executed by the at least one processor, cause the at least one processor to:
receive input resulting from activation of a particular selection button of a plurality of selection buttons;
determine a duration of the activation of the particular selection button;
compare the duration of the activation of the particular selection button to a threshold duration amount to determine whether the duration of the activation surpassed the threshold; and
in response to the comparison, select a character from a plurality of characters based on an identification of the particular selection button activated and whether the duration of the activation surpassed the threshold.

32. The device of claim 31 further comprising a display coupled to the at least one processor and wherein the computer executable instructions, when executed by the at least one processor, further cause the at least one processor to output the selected character on the display in response to the character being selected.

33. A non-transitory computer-readable storage medium having computer-executable instructions stored thereon that, when executed by at least one processor of a computer system, cause the computer system to:
receive input resulting from activation of a particular selection button of a plurality of selection buttons;
determine a duration of the activation of the particular selection button;
compare the duration of the activation of the particular selection button to a threshold duration amount to determine whether the duration of the activation surpassed the threshold; and
in response to the comparison, select a character from a plurality of characters based on an identification of the particular selection button activated and whether the duration of the activation surpassed the threshold.

34. The non-transitory computer-readable storage medium of claim 33 wherein the computer executable instructions, when executed by the at least one processor, further cause the at least one processor to output the selected character on a display.

35. A computer processor-implemented method comprising electronically enabling selection of either of two characters using one selection button by receiving input resulting from activation of the selection button, the duration of the activation specifying the selected character.
